(19) United States
(12) Patent Application Publication
(10) Pub. No.: US 2007/0295552 A1
(43) Pub. Date: Dec. 27, 2007

(54) Electric power steering apparatus

(75) Inventors: Katsuji Watanabe, Utsunomiya-shi (JP); Yasuo Shimizu, Shimotsuke-shi (JP); Takahiro Aoki, Moka-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/730,093

(22) Filed: Mar. 29, 2007

(30) Foreign Application Priority Data
Apr. 26, 2006 (JP) 2006-121864

(51) Int. Cl. B62D 5/04; F16H 35/00

(52) U.S. Cl. 180/444; 74/388 PS

(57) ABSTRACT

This electric power steering apparatus is provided with: a motor; a worm gear provided on a rotational shaft of the motor so as not to rotate with respect to the rotational shaft; a worm wheel gear which meshes with the worm gear and links to a steering system; a gear housing to which a motor housing of the motor is attached, and which accommodates the worm gear and the worm wheel gear; and a decentering device which makes the rotational shaft approach to or depart from a rotational axis of the worm wheel gear in a parallel manner thereto, by rotating the motor housing with respect to the gear housing.

### BACKGROUND OF THE INVENTION

Priority is claimed on Japanese Patent Application No. 2006-121864, filed Apr. 26, 2006, the contents of which are incorporated herein by reference.

1. Field of the Invention

The present invention relates to an electric power steering apparatus.

2. Description of the Related Art

Recently, an electric power steering apparatus is widely used for vehicles in order to reduce steering force required for operating a steering handle, and to thereby obtain a comfortable steering feeling.

The electric power steering apparatus generates an assisting torque corresponding to an operation torque by a motor, increases the assisting torque by a worm wheel mechanism, and thereafter transmits it to a steering system.

In a worm wheel mechanism of this kind of electric power steering apparatus, backlash between a worm gear and a worm wheel gear is a very serious problem which relates to noise generation. That is, the backlash is definitely necessary in order that the worm gear and the worm wheel gear mesh with each other to rotate; however, excessive backlash has a possibility of generating knocking noise while reversing torque input. Therefore, adjustment for the backlash is necessary.

Published Japanese Translation No. 2001-514122 of the PCT International Application discloses an electric power steering apparatus provided with a backlash adjusting mechanism that adjusts a backlash between a worm gear and a worm wheel gear. In this electric power steering apparatus, one end of an output shaft is attached to a motor rotor; another end of the output shaft is inserted into a gear housing; the worm gear is unitarily formed on a portion of the output shaft, where is housed in the gear housing; the another end and a portion close to the motor rotor of the output shaft are mounted on the gear housing via a first bearing and a second bearing; and the worm gear meshes with the worm wheel gear housed in the gear housing. The backlash adjusting mechanism is constructed from: a decentering device which enables the first axis supporting the another end of the output shaft to approach to or depart from a rotational axis of the worm wheel gear; and an angle adjusting device that can change an angle of the second axis supporting a portion of the output shaft where is close to the motor.

In the backlash adjusting mechanism, the backlash between the worm gear and the worm wheel gear is adjusted by the decentering device that changes a distance between the axes of the first bearing and the worm wheel gear, and by the angle adjusting device that changes the mounting angle of the output shaft with respect to the motor rotor. That is, the backlash is adjusted by inclining the output shaft, centering on the second bearing.

However, this kind of backlash adjusting mechanism had a problem in that the construction thereof is complex, and the productivity thereof is low.

In addition, in case of employing a motor having a construction in which a worm gear is unitarily provided to an end of the motor shaft that is arranged so as to penetrate a motor rotor, it was difficult to employ the above-mentioned backlash adjusting mechanism due to construction thereof.

Accordingly, the present invention has an object of providing an electric power steering apparatus that is simple, and enables easy adjustment of a backlash of a worm wheel mechanism.

### SUMMARY OF THE INVENTION

An electric power steering apparatus of the present invention employed the following constructions in order to achieve the above-mentioned object.

That is, an electric power steering apparatus of the present invention is provided with: a motor; a worm gear provided on a rotational shaft of the motor so as not to rotate with respect to the rotational shaft; a worm wheel gear which meshes with the worm gear and links to a steering system; a gear housing to which a motor housing of the motor is attached, and which accommodates the worm gear and the worm wheel gear; and a decentering device which makes the rotational shaft approach to or depart from a rotational axis of the worm wheel gear in a parallel manner thereto, by rotating the motor housing with respect to the gear housing.

According to the electric power steering apparatus, the decentering device can have a simple construction. In addition, when the motor housing is rotated with respect to the gear housing, the rotational shaft of the motor moves so as to approach to or depart from the rotational axis of the worm wheel gear in a parallel manner, by the decentering device: therefore, it is possible to adjust the distances between the axes of the worm gear and the worm wheel gear. As a result, it is possible to easily adjust the backlash between the worm gear and the worm wheel gear. Furthermore, since noise reduction can be made in the worm wheel mechanism, the silence of the electric power steering apparatus can be improved.

It may be arranged such that the electric power steering apparatus further includes a pair of bearings that support two ends of the worm gear so as to be rotatable around a first axis, and a bearing cap that accommodates one of the bearings and is attached to the gear housing, wherein: the another of the bearings is housed in the motor housing; and the decentering device includes: a first denting-and-protruding coupling portion which joins the motor housing with the gear housing so as to be rotatable thereto around a second rotational axis that is parallel with and depart from the first rotational axis; and a second denting-and-protruding coupling portion which joins the bearing cap with the gear housing so as to be rotatable thereto around the second rotational axis.

It may be arranged such that a first bolt hole is provided to at least one of the gear housing and the motor housing so as to be inserted with a first bolt which fixes therebetween; a second bolt hole is provided to at least one of the bearing cap and the gear housing so as to be inserted with a second bolt which fixes therebetween; and each of the first bolt hole and the second bolt hole is formed so as to form an arc shape centering on the second axis.

### BRIEF DESCRIPTION OF THE DRAWINGS

FIG. 1 shows a schematic construction view of an electric power steering apparatus according to one embodiment of the present invention.

FIG. 2 shows a detailed cross-sectional view of the electric power steering apparatus, taking along a line A-A in FIG. 1.

FIG. 3A shows a detailed cross-sectional view of the electric power steering apparatus, taking along a line B-B in FIG. 1, while FIG. 3B shows a relational arrangement between a protruding coupling portion of a bearing cap and a center of an output shaft.

FIG. 4A shows a partial cross-sectional view of a motor, while FIG. 4B shows a relational arrangement between the protruding coupling portion of the motor and the center of the output shaft.

### DETAILED DESCRIPTION OF THE INVENTION

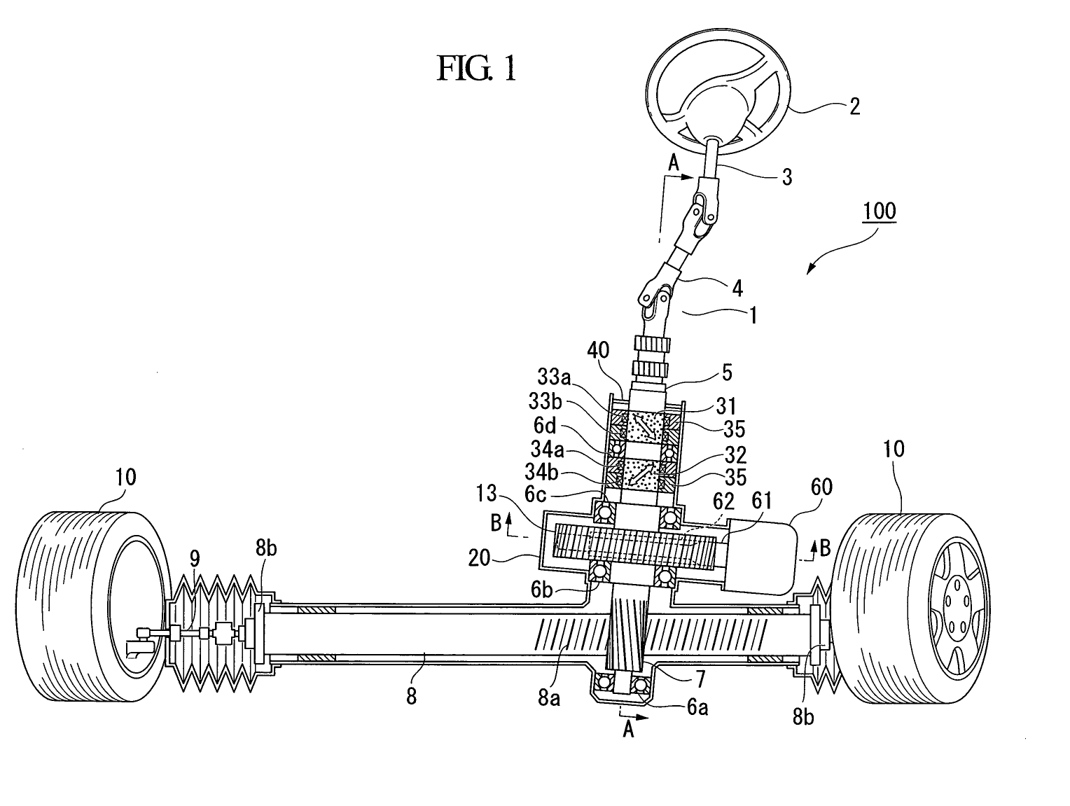

An electric power steering apparatus according to one embodiment of the present invention will be explained below with reference to FIGS. 1 to 4B.

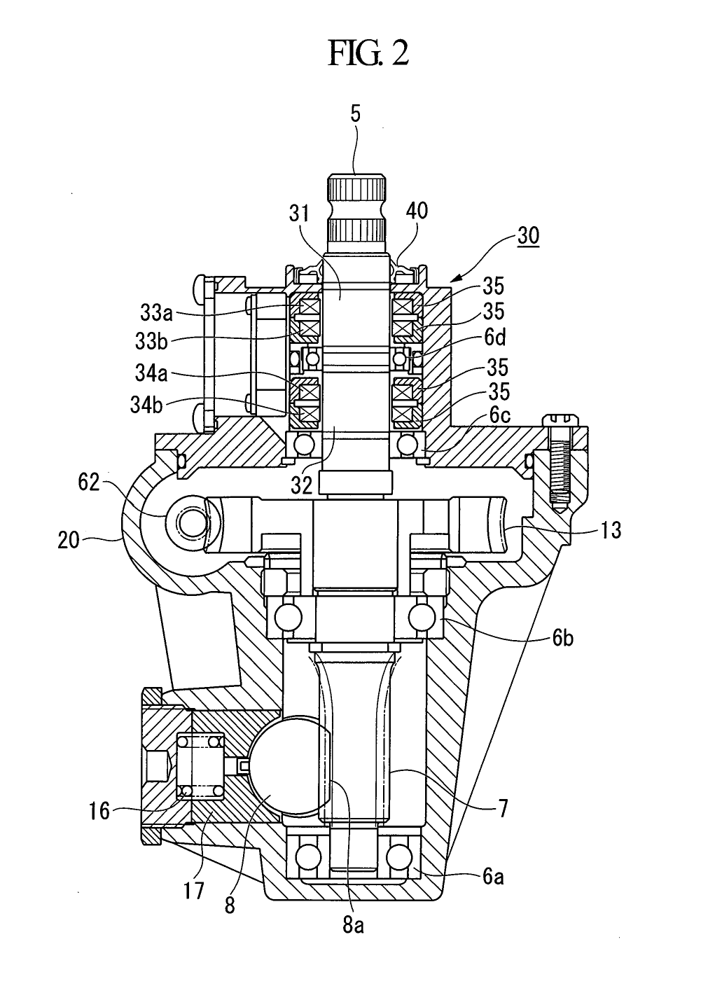

FIG. 1 shows a schematic construction of an electric power steering apparatus 100 of a vehicle, and FIG. 2 shows a detailed cross-sectional view of the electric power steering apparatus 100, taking along a line A-A in FIG. 1.

The electric power steering apparatus 100 is provided with a steering shaft 1 that is joined with a steering wheel (steering member) 2. The steering shaft 1 is constructed by joining a main steering shaft 3 that is unitarily joined with the steering wheel 2, with a pinion shaft 5 to which a pinion 7 of a rack-and-pinion mechanism is unitarily provided, through a universal joint 4.

The pinion shaft 5 is housed in a gear housing 20, a lower portion thereof is supported by a bearing 6a, a middle portion thereof is supported by bearings 6b and 6c, and an upper portion thereof is supported by a bearing 6d.

A worm wheel gear 13 is fittingly attached to the pinion shaft 5 at a portion between the bearings 6b and 6c. The pinion 7 is unitarily formed at a lower end portion of the pinion shaft 5 where is between the bearings 6a and 6b. The pinion 7 meshes with a rack 8a of a rack shaft 8 that can reciprocate in the vehicle width direction. The rack shaft 8 is pressed toward the pinion 7 by a rack guide 17 urged by a spring 16. Each of rack ends 8b provided on two ends of the rack shaft 8 is joined with a tie rod 9. Each of the tie rods 9 is linked to a front wheel 10 being a steering wheel. With this construction, a steering operation with a normal rack-and-pinion system can be made while steering the steering wheel 2, and thereby enabling steering of the front wheels 10 to change the direction of the vehicle. Moreover, the pinion shaft 5, the rack shaft 8, and the tie rods 9 form a steering system.

The electric power steering apparatus 100 is further provided with a steering motor (hereinafter “motor”) 60 including a brushless motor that generates assisting torque for reducing steering force by the steering wheel 2. The motor 60 is attached to a gear housing 20, and an output shaft (a rotational shaft) thereof is inserted into the gear housing 20. A worm gear 62 is formed on an output shaft 61 inserted into the gear housing 20, and meshes with the worm wheel gear 13. The worm gear 62 and the worm wheel gear 13 are housed together in the gear housing 20. The worm gear 62 and the worm wheel gear 13 form a reduction mechanism. Torque generated by the motor 60 is increased by the worm gear 62 and the worm wheel gear 13, and is then transmitted to the pinion shaft 5.

Magnetostriction films (magnetostriction portion) 31 and 32 are provided to an exterior of the pinion shaft 5 at an upper position and a lower position than the bearing 6d provided on the upper position of the pinion shaft 5, so as to sandwich the bearing 6d therebetween. Detection coils 33a, 33b, 34a, and 34b are arranged so as to face the magnetostriction films 31 and 32. The detection coils 33a, 33b, 34a, and 34b are each attached to the gear housing 20 via coil cases 35, and are connected to a detection circuit (not illustrated). This detection circuit converts the changes in inductances of the each detection coils 33a, 33b, 34a, and 34b that are generated in accordance with magnetostriction, to the changes in voltage, and then the detection circuit inputs them into a controller (not illustrated). The controller calculates operation torque applied to the steering shaft 1 based on the outputs from the detection circuit. In this electric power steering apparatus 100, the pinion shaft 5, the magnetostriction films 31 and 32, and the detection coils 33a, 33b, 34a, and 34b form a magnetostriction-type torque sensor 30 that detects the operation torque (input steering power).

An oil sealing 40 seals between a portion of the pinion shaft 5 where is higher than the magnetostriction film 31, and the gear housing 20.

In this electric power steering apparatus 100, the magnetostriction-type torque sensor 30 measures an operation torque (input steering power) by a driver, and the motor 60 is driven in response to the measured operation torque to steer the front wheels 10.

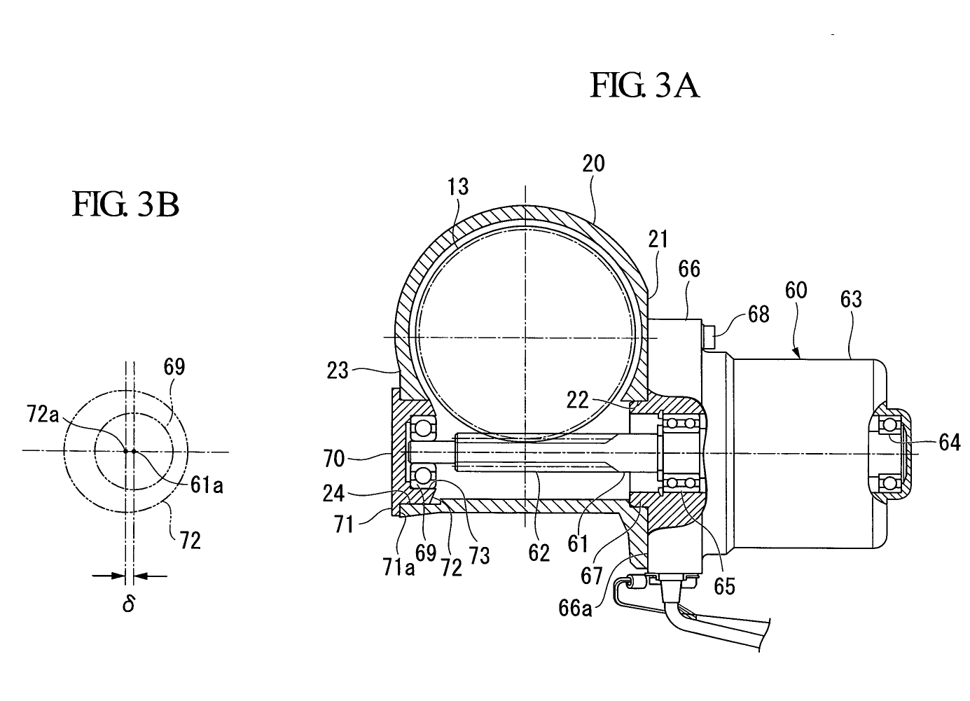

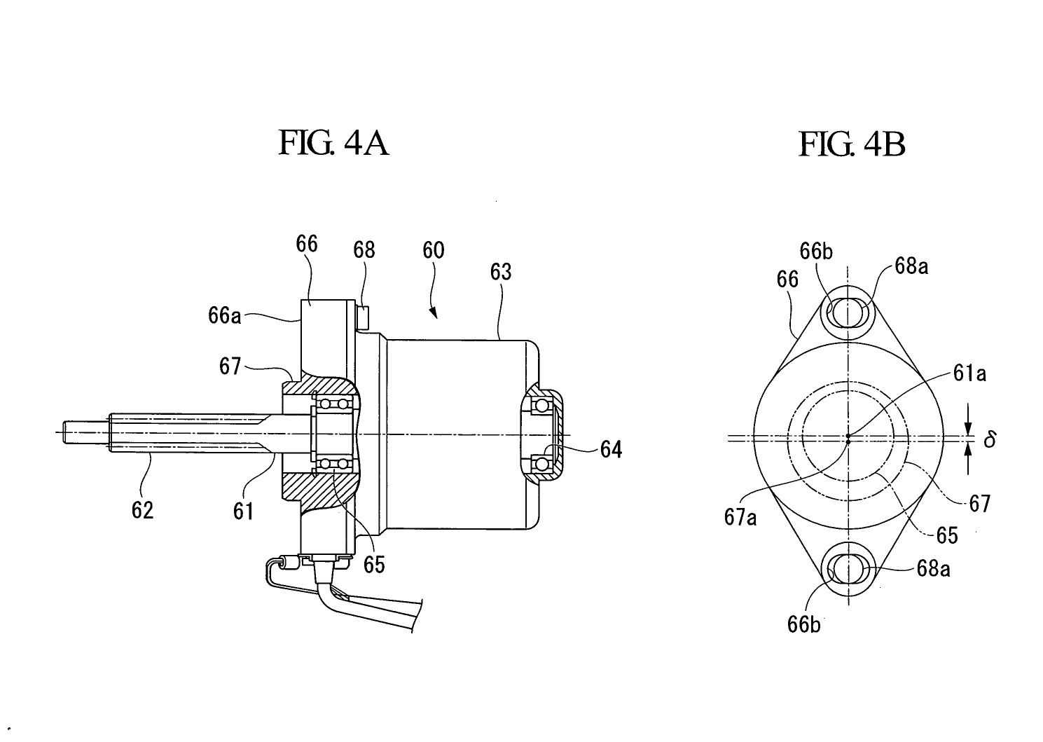

This electric power steering apparatus 100 is further provided with a decentering device that enables an output shaft 61 of the motor 60 to move in a parallel manner so as to approach to or depart from the rotational axis of the worm wheel gear 13. Details of the decentering device will be explained below with reference to FIGS. 3A to 4B.

The decentering device is provided at a connection between the gear housing 20 and the motor 60.

As shown in FIGS. 3A to 4B, the motor 60 includes a motor housing 63 that accommodates a stator and a rotor (these are not illustrated). One end of the output shaft 61 is supported by a motor housing 63 via a bearing 64, while a middle portion thereof is rotatably supported by a flange portion 66 via a bearing 65. The rotor is fixed to the output shaft 61 at a position between the bearings 64 and 65. Another end of the output shaft 61 protrudes to an outside from the flange portion 66 of the motor housing 63, and the above-mentioned worm gear 62 is unitarily formed on the another end. A protruding coupling portion 67 having a circular cross section that protrudes outward is formed on an end face 66a of the flange portion 66. As shown in FIG. 4B, a center 67a of the protruding coupling portion 67 is arranged so as to be shifted from a shaft center 61a (in other word, a center of the bearing 65) of the output shaft 61.

The motor 60 is attached to the gear housing 20 by abutting the end face 66a of the flange portion 66 to a flat motor-attaching face 21 formed on the gear housing 20, and by inserting the protruding coupling portion 67 into a circular fitting hole 22 formed in the motor-attaching face 21. The output shaft 61 is inserted into the inside of the gear housing 20. In the gear housing 20, the output shaft 61 is arranged so as to be departed from the pinion shaft 5 and be orthogonal to the pinion shaft 5.

The protruding coupling portion 67 is slidably rotatable in the circular fitting hole 22, before fixing the flange portion 66 by bolts 68 to the gear housing 20. As shown in FIG. 4B, each bolt-insertion hole 66b of the flange portion 66 through which male thread portion 68a of the bolt 68 is inserted is not formed in a circular hole but is formed in an arc-shaped hole centering on a center 67a of the protruding coupling portion 67.

In addition, another end of the output shaft 61 is rotatably supported by the gear housing 20 via a bearing 69 installed in a bearing cap 70. The bearing cap 70 includes a protruding coupling portion 72 that has a circular cross section and protrudes from a capping portion 71. And, a circular bearing hole 73 is formed in the inner side of the protruding coupling portion 72 so as to be inserted with the bearing 69. As shown in FIG. 3B, a center 72a of the protruding coupling portion 72 is arranged so as to be shifted with respect to the shaft center 61 a output shaft 61 (in other words, a center of the bearing 69). A decentering amount 8 between the center 72a of the protruding coupling portion 72 and the shaft center 61a of the output shaft 61 is set to be equivalent to a decentering amount 8 between the center 67a of the protruding coupling portion 67 and the shaft center 61a of the output shaft 61.

The bearing cap 70 is attached to the gear housing 20 by abutting an end face 71a of the capping portion 71 to a flat cap face 23 that is located at a position opposite to the motor-attaching face 21 in the gear housing 20, and by inserting the protruding coupling portion 72 into a circular coupling hole 24 formed in the cap face 23. Moreover, although not shown in the figures, the relation between: the bolts for fixing the bearing cap 70 to the gear housing 20; and the bolt-insertion holes of the bearing cap 70 through which the bolts are inserted, is set so as to be the same as the relation between the bolts 68 and the bolt-insertion holes 66b of the flange portion 66; therefore, the protruding coupling portion 72 is slidably rotatable in the coupling hole 24 before fixing the bearing cap 70 to the gear housing 20.

As has been explained in the above, the decentering device of the present embodiment is constructed by: the circular fitting hole 22 in the gear housing 20; the protruding coupling portion 67 of the motor housing 63; the coupling hole 24 of the gear housing 20; and the protruding coupling portion 72 of the bearing cap 70. Accordingly, the decentering device has an extremely simple construction.

Next, operations of the decentering device will be explained below. The decentering device is used for adjusting backlash between the worm gear 62 and the worm wheel gear 13. The adjustment on the backlash can be performed at the assembling of, or at after the assembling of the electric power steering apparatus 100.

The backlash adjustment can be performed as described below if the backlash adjustment is performed during the assembly of the electric power steering apparatus 100. Firstly, the pinion shaft 5 to which the worm wheel gear 13 is attached is set into the gear housing 20. Next, the output shaft 61 of the motor 60 is inserted through the circular fitting hole 22 of the gear housing 20; the protruding coupling portion 67 is fitted into the circular fitting hole 22; and then the worm gear 62 of the output shaft 61 meshes with worm wheel gear 13. Moreover, at this stage, the bearing 69 and the bearing cap 70 are not attached to an distal end of the output shaft 61.

Then, the motor housing 63 is rotated with respect to the gear housing 20, while maintaining the face contact between the end face 66a of the flange portion 66 of the motor 66 and the motor-attaching face 21 of the gear housing 20. Then, since the distal end side of the output shaft 61 is free and since the center of the protruding coupling portion 67 is shifted with respect to the shaft center 61a of the output shaft 61 of the motor 60, the output shaft 61 moves in a parallel manner so as to approach to or depart from the rotation center of the worm wheel gear 13. With these process, the distance between the axis of the worm gear 62 and the axis of the worm wheel gear 13 can be adjusted, and as a result, it is possible to adjust the backlash between the worm gear 62 and the worm wheel gear 13, to a suitable value.

After adjusting the backlash, the bearing 69 is fitted to the distal end of the output shaft 61, and the bearing cap 70 is attached into the coupling hole 24 of the gear housing 20. Moreover, since the center of the protruding coupling portion 72 of the bearing cap 70 is shifted with respect to the center of the bearing (i.e., the shaft center 61a of the output shaft 61), it is possible to insert the protruding coupling portion 72 into the coupling hole 24, while inserting the bearing 69 into the bearing hole 73, even after the backlash adjustment.

In addition, after the assembly of the electric power steering apparatus 100, the bolts that fix the bearing cap 70 to the gear housing 20, and the bolts 68 that fix the motor housing 63 to the gear housing 20 are loosened. Then, the motor housing 63 is rotated with respect to the gear housing 20 to move the output shaft 61 of the motor 60 in a parallel manner; and thereafter, the bearing cap 70 is rotated in the coupling hole 24.

As has been explained in the above, the electric power steering apparatus 100 of the present embodiment can easily adjust the backlash between the worm gear 62 and the worm wheel gear 13, to an optimal value. In addition, since the backlash can be adjusted to the optimal value, a torque transmission between the worm gear 62 and the worm wheel gear 13 can be performed smoothly, and the knocking noise while reversing torque input can be suppressed. As a result, the silence of the electric power steering apparatus 100 can be improved.

Moreover, in the present embodiment, the worm gear 62 is unitarily formed to the output shaft 61 (rotational shaft) of the motor 60; however, the present invention is not limited to this construction. For example, it may be arranged such that a worm gear is independently formed besides an output shaft, and is fitted to the exterior of the output shaft so as not to rotate thereto, to make the output shaft and the worm gear form one unit.

While a preferred embodiment of the invention has been described and illustrated above, it should be understood that this is an exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATIONS FOR REFERENCE SYMBOLS

13 . . . worm wheel gear;
20 . . . gear housing;
22 and 24 . . . fitting hole (decentering device);
60 . . . motor;
61 . . . output shaft (rotational axis);
62 . . . worm gear;
63 . . . motor housing;
67 and 72 . . . protruding coupling portion (decentering device);
100 . . . electric power steering apparatus.

What is claimed is:

1. An electric power steering apparatus comprising:
a motor;
a worm gear provided on a rotational shaft of the motor so as not to rotate with respect to the rotational shaft;
a worm wheel gear which meshes with the worm gear and links to a steering system;
a gear housing to which a motor housing of the motor is attached, and which accommodates the worm gear and the worm wheel gear; and
a decentering device which makes the rotational shaft approach to or depart from a rotational axis of the worm wheel gear in a parallel manner thereto, by rotating the motor housing with respect to the gear housing.

2. The electric power steering apparatus according to claim 1, further comprising a pair of bearings that support two ends of the worm gear so as to be rotatable around a first axis, and a bearing cap that accommodates one of the bearings and is attached to the gear housing, wherein:
the another of the bearings is housed in the motor housing; and
the decentering device includes:
a first denting-and-protruding coupling portion which joins the motor housing with the gear housing so as to be rotatable thereto around a second rotational axis that is parallel with and depart from the first rotational axis; and
a second denting-and-protruding coupling portion which joins the bearing cap with the gear housing so as to be rotatable thereto around the second rotational axis.

3. The electric power steering apparatus according to claim 2, wherein:
a first bolt hole is provided to at least one of the gear housing and the motor housing so as to be inserted with a first bolt which fixes therebetween;
a second bolt hole is provided to at least one of the bearing cap and the gear housing so as to be inserted with a second bolt which fixes therebetween; and
each of the first bolt hole and the second bolt hole is formed so as to form an arc shape centering on the second axis.
